(19) United States
(12) Patent Application Publication
(10) Pub. No.: US 2014/0050824 A1
(43) Pub. Date: Feb. 20, 2014

(54) INTEGRATING ANALYSIS AND PRODUCTION OF A FOOD PRODUCT

(71) Applicant: ASPECT IMAGING LTD., Shoham (IL)

(72) Inventor: Uri RAPOPORT, Moshav Ben Shemen (IL)

(73) Assignee: ASPECT IMAGING LTD., Shoham (IL)

(21) Appl. No.: 13/906,871

(22) Filed: May 31, 2013

Related U.S. Application Data
(60) Provisional application No. 61/683,230, filed on Aug. 15, 2012.

(51) Int. Cl. G01N 24/08

(52) U.S. Cl. CPC G01N 24/08
USPC 426/231; 324/318

(57) ABSTRACT

A system for integrating analysis and production of a food product. The system includes: a food production apparatus for producing a food product; an MRI device configured to provide at least one image of at least a portion of the product's components; and a processor for analyzing and controlling the production of the product. The system analyzes an MRI image online and communicates results of the analysis to the food production apparatus.

### FIELD OF THE INVENTION

The present invention relates a system and method for integrating analysis and production of a food product.

### BACKGROUND OF THE INVENTION

Manufacturing industries such as the food industry typically use extractive sampling for testing the quality of products in order to determine if the products fulfill manufacturing criteria. In the most common form of extractive sampling, the sample is tested “off-line”; it is taken from the production line, analyzed in special-purpose analysis equipment, often in a laboratory, and discarded. This method is expensive, time consuming, and impractical for control purposes, since the testing procedure and monitoring of the process are performed externally to the production line. Furthermore, such analysis is usually performed late in the production process so that, if significant defects are found, the batch must be discarded or significant rework needs to be performed, resulting in significant waste.

There has been previous work on integrating sampling and analysis with production processes.

U.S. Pat. No. 5,532,593 to Maneval et al. describes an apparatus and method for obtaining rheological information about a fluid using nuclear magnetic imaging techniques. In Maneval, a fluid flowing through a tube is subjected to nuclear magnetic resonance imaging signals to obtain the velocity profile of the fluid. The pressure gradient between two points along the tube is also obtained. The shear rate is then determined from the velocity profile, and the shear stress is determined from the pressure gradient. From a single velocity profile, data is obtained over shear rates ranging from zero at the center of the tube to the maximum shear rate at the tube wall. Alternatively, the velocity spectrum can be obtained and used in the same manner. The shear stress versus shear rate curve can thereby be obtained from a single nuclear magnetic resonance image taken at a specific value of the pressure gradient. However, Maneval et al does not teach applying the rheological values thus obtained to foodstuffs.

A recent development has been the effort by an industrial consortium to standardize sensors and the sensing platform used for process monitoring, the New Sensors/Sampling Initiative (NeSSI) sponsored by the Center for Process Analytical Chemistry (CPAC) at the University of Washington.

The goal of NeSSI implementation is to automate, miniaturize and modularize process analytical systems used in industry, and to standardize the communication bus used in process analytical systems. The NeSSI platform is a miniaturized, modular version of traditional sample gathering and handling methodologies.

One of the benefits of a system such as the NeSSI system is the ability to integrate the sensing system with the sampling system to form a single unit for sample extraction, conditioning and measurement. An additional benefit of an integrated system is that it enables sampling and sensing during processing, thereby permitting process corrections earlier in the process, before the final product is manufactured, thereby minimizing output of defective product.

U.S. Pat. No. 7,057,156 to Coates et al. describes integration of an optical spectral sensing system with a modular sampling system, including an optical filter assembly, for monitoring output from an energy source. Although this prior art system fulfills NeSSI industrial requirements, it does not describe relating NeSSI requirements to the food industry. Furthermore, it does not teach use of MRI for the sensing system.

A publication, “Think Small: Low-Cost Spectral Measurements for Chemical Sensing” by John Coates, Spectroscopy 21(10), October 2006, discusses the application of optical analyzers and systems to various industries. However, this prior art does not describe using the NeSSI protocols and requirements in the food industry.

None of the prior art systems disclose an apparatus and method intended for use in the food industry which conforms to NeSSI standards and which permits correction of a process on-line in real time.

Thus, there is a long felt and need for a system which does not require off-line testing of samples, in which processing errors are not caught only near the end of processing and in which no external intervention is needed to correct processing errors.

### SUMMARY OF THE INVENTION

It is an object of the present invention to disclose a system for integrating analysis and production of a food product.

In the present invention, a criterion of a sample of the food product is measured and the measured value is compared to a standard. If the measured value differs from the standard by more than a predetermined amount, at least one production characteristic of the production process is altered. This process of measurement, comparison, and modification of the production process is repeated iteratively until the measured value differs from the standard by less than the predetermined amount.

It is an object of the present invention to provide a system for integrating analysis and production of a food product comprising: (a) food production apparatus for producing a food product in at least one characterized production step; (b) an MRI device configured to provide at least one image of at least a portion of the product's components at the at least one characterized production step; and (c) a processor for analyzing and controlling the production of the product; wherein the system is operating in a method of (i) analyzing the MRI image online; (ii) operatively communicating results of the analysis to the food production apparatus; (iii) online feedback controlling at least one step in the operation of the food production apparatus, thereby controlling automatically the at least one step in the operation of the apparatus.

It is another object of the present invention to provide the system for integrating analysis and production of a food product, wherein the production steps are selected from a group consisting of adding ingredients, mixing, shaking, rotating, tumbling, aerating, heating, cooling, holding at a fixed temperature, emulsifying, kneading, and any combination thereof.

It is another object of the present invention to provide the system for integrating analysis and production of a food product, wherein the means for analyzing at least one criterion of the composition of the food product generates at least one radial velocity profile from the at least one magnetic resonance image.

It is another object of the present invention to provide the system for integrating analysis and production of a food product, wherein the means for analyzing at least one criterion of the composition of the food product generates at least two radial pressure profiles.

It is another object of the present invention to provide the system for integrating analysis and production of a food product, wherein the means for analyzing at least one criterion of the composition of the food product generates at least one rheological parameter of the composition of the food product from at least one of the at least one radial velocity profile and the at least two radial pressure profiles.

It is another object of the present invention to provide the system for integrating analysis and production of a food product, wherein the at least one rheological parameter is selected from a group consisting of radial shear stress parameter γ(r), radial shear rate parameter γ(r), and any combination of thereof.

It is another object of the present invention to provide the system for integrating analysis and production of a food product, wherein the means for analyzing at least one criterion of the composition of the food product generates stress parameters k and n in the power law equation σ(r)=k[γ(r)]ⁿ from rheological parameters radial shear stress parameter σ(r) and radial shear rate parameter γ(r).

It is another object of the present invention to provide the system for integrating analysis and production of a food product, wherein the means for analyzing at least one criterion of the composition of the food product is further configured to determine at least one quality parameter Q from the at least one rheological parameter.

It is another object of the present invention to provide the system for integrating analysis and production of a food product, wherein the quality parameter is Q=\sqrt{k²±n²}.

It is another object of the present invention to provide the system for integrating analysis and production of a food product, wherein standard quality parameter Q_{S}=\sqrt{k_{S}²+n_{S}²} is generated from analysis of a standardized sample of the food product composition, the analysis of the standardized sample generating standardized stress parameters k_{S} and n_{S} in the power law equation σ_{S}(r)=k_{S}[γ_{S}(r)]ⁿ^{_{S}} from rheological parameters standardized radial shear stress parameter σ_{S}(r) and standardized radial shear rate parameter γ_{S}(r).

It is another object of the present invention to provide the system for integrating analysis and production of a food product, wherein composition quality parameter Q_{C}=⇄\sqrt{k_{C}²+n_{C}²} is generated from analysis of a sample of the food product composition, the analysis of the composition sample generating composition stress parameters k_{C} and n_{C} in the power law equation σ_{C}(r)=k_{C}[γ_{C}(r)]ⁿ^{_{C}} from rheological parameters composition radial shear stress parameter σ_{C}(r) and composition radial shear rate parameter γ_{C}(r).

It is another object of the present invention to provide the system for integrating analysis and production of a food product, wherein a quality test parameter is: Q_{T}=|Q_{S}−Q_{C}|.

It is another object of the present invention to provide the system for integrating analysis and production of a food product, wherein the quality criterion is: the quality test parameter is smaller than one standard deviation of the standard quality parameter.

It is another object of the present invention to provide the system for integrating analysis and production of a food product, wherein the standard deviation is one standard deviation of the standard quality parameter.

It is another object of the present invention to provide the system for integrating analysis and production of a food product, wherein the standard deviation is one standard deviation of the composition quality parameter.

It is another object of the present invention to provide the system for integrating analysis and production of a food product, wherein the alterable at least one parameter is selected from a group consisting of addition of an ingredient, the rate of addition of an ingredient, mixing rate, mixing time, rate of change of mixing rate, shaking rate, shaking time, rate of change of shaking rate, rotation rate, rotation time, rate of change of rotation rate, tumbling rate, tumbling time, rate of change of tumbling rate, aeration rate, aeration time, rate of change of aeration rate, heating rate, heating time, rate of change of heating rate, shaking rate, shaking time, rate of change of heating rate, cooling rate, cooling time, rate of change of cooling rate, time held at a constant temperature, emulsification rate, emulsification time, rate of change of emulsification rate, kneading rate, kneading time, rate of change of kneading rate, and any combination thereof.

It is another object of the present invention to provide the system for integrating analysis and production of a food product wherein the alterable at least one parameter comprises addition of an ingredient; the ingredient stored in an the ingredient supply system comprising a plurality of ingredient supply reservoirs, each reservoir of the plurality of ingredient supply reservoirs comprising at least one ingredient of the plurality of ingredients.

It is another object of the present invention to provide the system for integrating analysis and production of a food product, wherein, if the quality parameter satisfies the quality criterion, a further batch of the food composition is input to the food production line.

It is another object of the present invention to provide the system for integrating analysis and production of a food product, wherein, if the quality parameter does not satisfy the quality criterion, the processor instructs the ingredient supply system to inject a quantity of at least one ingredient into the composition,

It is another object of the present invention to provide the system for integrating analysis and production of a food product, wherein the at least one criterion of at least one composition of the food product is selected based on its relationship to at least one of a group consisting of: food product aroma, and food product taste.

It is another object of the present invention to provide the system for integrating analysis and production of a food product, wherein at least a part of the food production equipment is configured to comply with a NeSSI specification.

It is another object of the present invention to provide the system for integrating analysis and production of a food product, wherein at least a part of the food production equipment is configured to comply with ANSI/ISA SP76.00.2002 miniature, modular mechanical standard specifications.

It is another object of the present invention to provide the system for integrating analysis and production of a food product, wherein the food production equipment comprises a NeSSI communication bus.

It is another object of the present invention to provide a method for integrating analysis and production of a food product comprising steps of: (a) providing a system for integrating analysis and production of a food product comprising: (i) food production apparatus for producing a food product in at least one characterized production step; (ii) an MRI device configured to provide at least one image of at least a portion of the product's components at the at least one characterized production step; and (iii) a processor for analyzing and controlling the production of the product; (b) providing at least one sample of the food product at the characterized production step; (c) MRI imaging the sample of the food product at the characterized production step; (d) analyzing the MRI image online; (e) operatively communicating results of the analysis to the food production apparatus, thereby enabling automatic online control of production; and (f) online feedback controlling at least one step in the operation of the food production apparatus, thereby controlling automatically the at least one step in the operation of the apparatus.

It is another object of the present invention to provide the method for integrating analysis and production of a food product, additionally comprising a step of selecting the food production steps from a group consisting of adding ingredients, mixing, shaking, rotating, tumbling, aerating, heating, cooling, holding at a fixed temperature, emulsifying, kneading, and any combination thereof.

It is another object of the present invention to provide the method for integrating analysis and production of a food product, additionally comprising a step of determining a standardized quality parameter, the standardized quality parameter determined from the analysis of the sample of the standardized composition of the food product.

It is another object of the present invention to provide the method for integrating analysis and production of a food product, additionally comprising a step of determining a quality criterion from the analysis of the sample of the standardized composition of the food product.

It is another object of the present invention to provide the method for integrating analysis and production of a food product, additionally comprising a step of analyzing the composition of the food product to generate at least one radial velocity profile of the composition of the food product from the at least one magnetic resonance image.

It is another object of the present invention to provide the method for integrating analysis and production of a food product, additionally comprising a step of generating at least two radial pressure profiles of the composition of the food product.

It is another object of the present invention to provide the method for integrating analysis and production of a food product, additionally comprising a step generating at least one rheological parameter of the composition of the food product from at least one of the at least one radial velocity profile and the at least two radial pressure profiles.

It is another object of the present invention to provide the method for integrating analysis and production of a food product, additionally comprising a step of selecting the at least one rheological parameter from a group consisting of radial shear stress parameter σ(r), radial shear rate parameter γ(r), and any combination of thereof.

It is another object of the present invention to provide the method for integrating analysis and production of a food product, additionally comprising a step of generating stress parameters k and n in the power law equation σ(r)=k[γ(r)]ⁿ from rheological parameters radial shear stress parameter σ(r) and radial shear rate parameter γ(r).

It is another object of the present invention to provide the method for integrating analysis and production of a food product, additionally comprising a step of determining at least one quality parameter Q from the at least one rheological parameter.

It is another object of the present invention to provide the method for integrating analysis and production of a food product, additionally comprising a step of generating the quality parameter from Q=\sqrt{k²+n²}.

It is another object of the present invention to provide the method for integrating analysis and production of a food product, additionally comprising a step of generating standard quality parameter Q_{S}=\sqrt{k_{S}²+n_{S}²} from analysis of a standardized sample of the food product composition, the analysis of the standardized sample generating standardized stress parameters k_{S} and n_{S} in the power law equation σ_{S}(r)=k_{S}[γ_{S}(r)]ⁿ^{_{S}} from rheological parameters standardized radial shear stress parameter σ_{S}(r) and standardized radial shear rate parameter γ_{S}(r).

It is another object of the present invention to provide the method for integrating analysis and production of a food product, additionally comprising a step of generating composition quality parameter Q_{C}=\sqrt{k_{C}²+n_{C}²} from analysis of a sample of the food product composition, the analysis of the composition sample generating composition stress parameters k_{C} and n_{C} in the power law equation σ_{C}(r)=k_{C}[γ_{C}(r)]ⁿ^{_{C}} from rheological parameters composition radial shear stress parameter σ_{C}(r) and composition radial shear rate parameter γ_{C}(r).

It is another object of the present invention to provide the method for integrating analysis and production of a food product, additionally comprising a step of generating quality test parameter Q_{T}=|Q_{S}−Q_{C}|.

It is another object of the present invention to provide the method for integrating analysis and production of a food product, additionally comprising a step of setting the quality criterion as: the quality test parameter is smaller than one standard deviation of the standard quality parameter.

It is another object of the present invention to provide the method for integrating analysis and production of a food product, additionally comprising a step of setting the quality criterion as: the quality test parameter is smaller than one standard deviation of the composition quality parameter.

It is another object of the present invention to provide the method for integrating analysis and production of a food product, additionally comprising a step of selecting the alterable at least one parameter from a group consisting of addition of an ingredient, the rate of addition of an ingredient, mixing rate, mixing time, rate of change of mixing rate, shaking rate, shaking time, rate of change of shaking rate, rotation rate, rotation time, rate of change of rotation rate, tumbling rate, tumbling time, rate of change of tumbling rate, aeration rate, aeration time, rate of change of aeration rate, heating rate, heating time, rate of change of heating rate, shaking rate, shaking time, rate of change of heating rate, cooling rate, cooling time, rate of change of cooling rate, time held at a constant temperature, emulsification rate, emulsification time, rate of change of emulsification rate, kneading rate, kneading time, rate of change of kneading rate, and any combination thereof.

It is another object of the present invention to provide the method for integrating analysis and production of a food product, additionally comprising a step of selecting addition of an ingredient as at least one the alterable at least one parameter; the ingredient stored in an the ingredient supply system comprising a plurality of ingredient supply reservoirs, each reservoir of the plurality of ingredient supply reservoirs comprising at least one ingredient of the plurality of ingredients.

It is another object of the present invention to provide the method for integrating analysis and production of a food product, additionally comprising a step of inputting a further batch of the food composition to the food production line if the quality parameter satisfies the quality criterion.

It is another object of the present invention to provide the method for integrating analysis and production of a food product, additionally comprising a step of injecting a quantity of at least one ingredient into the composition if the quality parameter does not satisfy the quality criterion.

It is another object of the present invention to provide the method for integrating analysis and production of a food product, additionally comprising a step of selecting the at least one criterion of at least one composition of the food product based on its relationship to at least one of a group consisting of: food product aroma, and food product taste.

It is another object of the present invention to provide the method for integrating analysis and production of a food product, additionally comprising a step of configuring at least a part of the food production equipment to comply with a NeSSI specification.

It is another object of the present invention to provide the method for integrating analysis and production of a food product, additionally comprising a step of configuring at least a part of the food production equipment to comply with ANSI/ISA SP76.00.2002 miniature, modular mechanical standard specifications.

It is another object of the present invention to provide the method for integrating analysis and production of a food product, additionally comprising a step of providing at least a part of the food production equipment with a NeSSI communication bus.

It is another object of the present invention to provide the method for integrating analysis and production of a food product, additionally comprising steps of repeating the comparing and the adjusting iteratively for each remaining batch of the plurality of batches.

It is another object of the present invention to provide the method for integrating analysis and production of a food product, additionally comprising a step of selecting at least one food product criterion in accordance with customer requirements.

It is another object of the present invention to provide the method for integrating analysis and production of a food product, additionally comprising a step of selecting at least one food product criterion from a group consisting of: food product aroma, food product taste and any combination thereof.

### BRIEF DESCRIPTION OF THE DRAWINGS

A preferred embodiment of the current invention is described hereinbelow with reference to the following drawings:

FIG. 1 shows a process analyzer, in accordance with prior art;

FIG. 2 shows a system for managing ingredients of a food product in a food production line, in accordance with a preferred embodiment of the present invention; and

FIG. 3 presents further details of the food production line, in accordance with a preferred embodiment of the present invention.

### DETAILED DESCRIPTION OF THE PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, will remain apparent to those skilled in the art, since the generic principles of the present invention have been defined specifically to provide a means and method for integrating analysis and production of a food product.

The term ‘plurality’ hereinafter refers to any integer greater than one.

The present invention provides a system and method for integrating analysis and production of a food product. It describes a feedback system which is preferably applicable to food production, thereby preventing food wastage and permitting food quality control.

In some embodiments of the present invention, nuclear magnetic resonance images are adapted to the food industry in order to provide quality management for a food product. In this embodiment, rheological parameters, such as a shear stress and shear rate, of a sample of a food product are acquired from at least one magnetic resonance image of the sample. The sample's rheological parameters are compared to corresponding rheological parameters of a standardized sample of the food product. Based on this comparison, a quality control parameter is determined. If a quality test parameter is less than or equal to a predetermined check value, the production of the food product continues with the current quantities of ingredients. However, if the quality test parameter is larger than the predetermined check value, the ingredients of the food product are iteratively adjusted until predetermined criteria are accomplished.

In some embodiments, a typical predetermined check value is that the quality parameter for the composition should be within one standard deviation of a corresponding quality parameter for the standardized sample of the food product. If the quality parameter for the composition differs from the standardized value by more than one standard deviation of the quality parameter of the standardized sample, the quantities of the food product's ingredient are iteratively adjusted, either singly or in combination, until the predetermined criterion is achieved.

In some embodiments, an ingredient processing system interfaces between a mixing vat system of the food production line and the magnetic resonance device, which generates magnetic resonance images of the food flow, from which rheological parameters of the food product are determined. The ingredient processing system fulfills the NeSSI protocols and requirements.

In the present invention, recent developments in industrial process improvement initiatives are adopted such as incorporating an on-line testing and adjusting system for iteratively adjusting the food product's ingredients. Another recent development incorporated in the present invention is the integration of sensing devices and monitoring processes into the sampling system. The mechanism preferably adopted is the NeSSI (New Sensors/Sampling Initiative).

The NeSSI (New Sampling/Sensor Initiative) requirements fulfill the ANSI/ISA SP76.00.2002 miniature, modular mechanical standard and include mechanical systems associated with the fluid handling components. The ANSI/ISA standard is referenced by the International Electrotechnical Commission in publication IEC 62339-1:2006. Preferably, the food production line uses mechanical designs based on the ANSI/ISA SP76.00.02-2002 Standard.

The NeSSI platform is a miniaturized, modular version of traditional sample gathering and handling methodologies, thus permitting the addition of components as standard modules, and the integration of the sensing system with the sampling system to form a single stand-alone unit for sample extraction and measurement. Using the NeSSI platform, process corrections may be detected earlier in the food product production line, thereby minimizing defective food production and food wastage.

The Magnetic Resonance Device (MRD) of Aspect Technologies is typically useful for the food industry, especially, as in the present invention, for managing ingredients. The MRD is a relatively small nuclear magnetic resonance device with ˜1 Tesla magnetic field, on the order of 0.5 m×0.5 m×1 m in size. Thus, the MRD device is ideal for incorporating in an on-line system, especially, in the food production line.

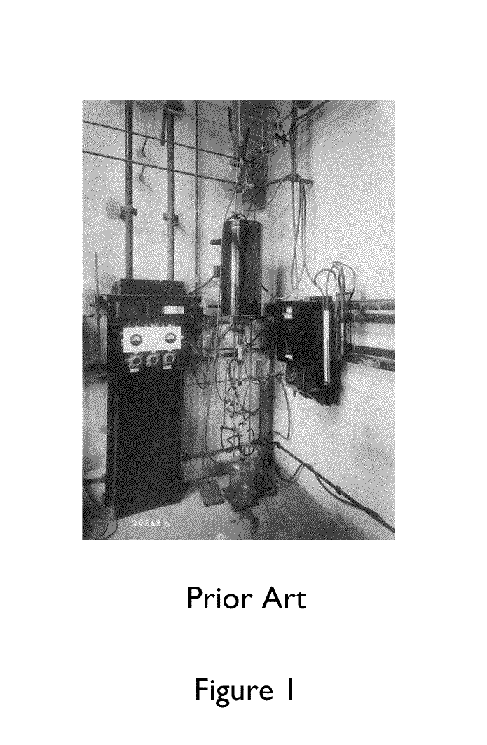

Reference is made to FIG. 1, showing a process analyzer of the prior art. The analyzer is not small and is not closely coupled to the food production line, making close control of the quality of the food product difficult.

In the present invention, at least one criterion of a sample of the food product is measured and the at least one measured value is compared to at least one standard. If the measured value differs from the standard by more than a predetermined amount, at least one production characteristic of the production process is altered. This process of measurement, comparison, and modification of the production process is repeated iteratively until the measured value differs from the standard by less than the predetermined amount.

A preferred embodiment of the present invention is now given. In this embodiment, the criteria are rheological parameters of the flowing food product, the rheological parameters are measured using a magnetic resonance imaging device, and the production characteristic which is to be altered is the quantity of at least one ingredient of the food product.

Other production characteristics which can be altered include, but are not limited to, the temperature at which at least one step in the process is carried out, the rate of change of temperature during the at least one step, the difference in temperature between two points in a production line, the difference in pressure between two points in a production line, the time for which the at least one step is carried out, and the speed at which the at least one step is carried out, where the speed can be the speed of rotation or the rate of vibration of beaters in a mixer, the speed of rotation or the rate of vibration of a vat or of a tumbling barrel, the speed of flow of the product in a duct, and any combination of the above.

Other possible criteria for the sample include, but are not limited to, its color or its spectral characteristics, its viscosity, its temperature, its degree of transparency, the temperature profile of the sample, and its chemical makeup. Sensors may include, but are not limited to, accelerometers, pressure sensors, stress sensors, spectrometers, diffraction gratings and other spectral analyzers, viscometers, and thermometers.

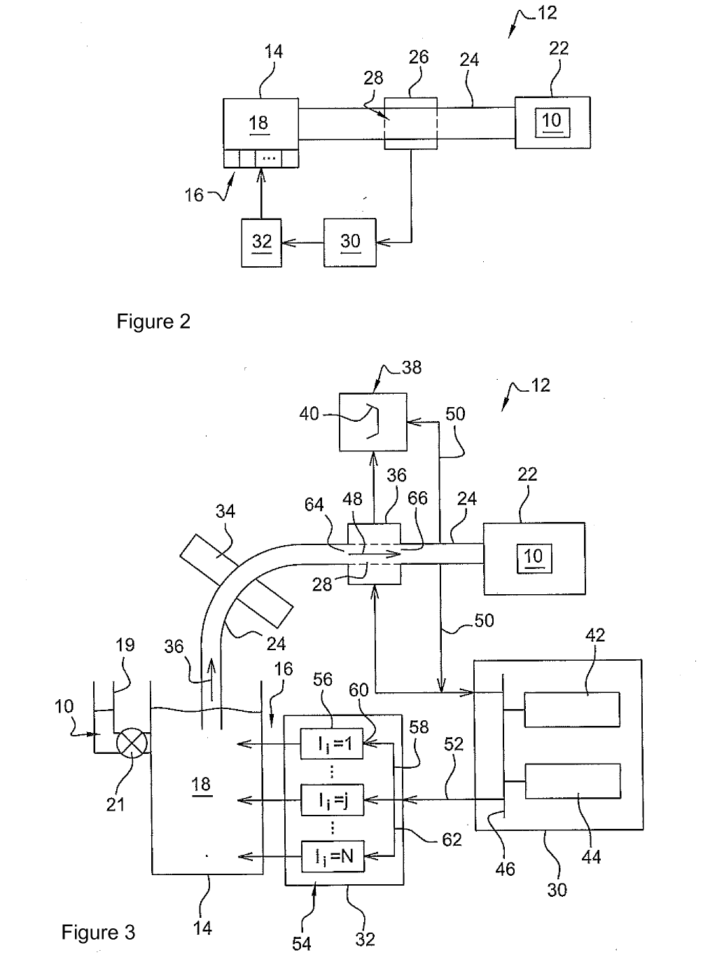

Reference is now made to FIG. 2, which shows an embodiment of the system. In this embodiment, the food product 10 is in a food production line 12. The food production line 12 comprises an ingredient supply device 32, a food mixing vat system 14, a flow conduit 24, and a food production device 22. It also comprises a magnetic resonance imaging device 26 encompassing at least a portion 28 of the flow conduit 24 and a processing system 30. During operation of the food production line, a plurality of ingredients 16 are injected into the mixing vat system 14, and are mixed until they form a food composition 18 of food product 10. The food composition 18 is then injected via conduit 24 into food production device 22 and food product 10 is produced in food production device 22.

The magnetic image resonance device 26 is monitors the process on line and in real time. A sample of food composition 18 is injected into flow conduit 24, such that the magnetic resonance imaging device 26 generates at least on magnetic resonance image of the food composition 18 flowing through the conduit 24. The processing system 30 processes the at least one magnetic resonance image of the sample of the food composition 18 to generate a quality test parameter Q_{T}, of the composition 18, as described below. The quality test parameter Q_{T} is compared to a predetermined check value Q_{C}, as described below, and if the difference is greater than a predetermined amount, the ingredient supply device 32 is instructed to supply a predetermined amount of at least one ingredient 16 to mixing vat system 14. When the ingredient 16 has been incorporated into food composition 18, another sample of food composition 18 is injected into flow conduit 24, another at least one magnetic resonance image is generated, and the process is repeated iteratively until the quality test parameter Q_{T} differs from the predetermined check value Q_{C} by less than the predetermined amount. In a batch system, the process will terminate when mixing vat system 14 is empty, although no adjustments to the composition 18 are expected to be necessary after an acceptable composition has been attained, and the process will recommence when mixing vat system 14 has been refilled and a new batch of composition 18 has been produced. In a continuous process, there is continuous injection of ingredients 16 into mixing vat system 14, so that the contents of mixing vat system 14 are constantly being replenished.

The ingredient processing system 30 is configured to comply with ANSI/ISA SP76.00.2002 miniature, modular mechanical standard specifications.

Reference is now made to FIG. 3, which presents further details of the food production line 12, in accordance with a preferred embodiment of the present invention. As shown in FIG. 3, the food production line 12 comprises a vat 14, a batch manifold 19 and control valve 21, a pump 34, a conduit 24, and a food production device 22. It further comprises an ingredient processing system 30 and an ingredient supply device 32.

The ingredient processing system 30 comprises a processor 42, a memory unit 44 and a communications bus 46, such as a NeSSI communications bus, enabling communications between all parts of the system.

The ingredient processing system 30 communicates with the ingredient supply device 32 by means of a communications line 52. The ingredient supply device 32 comprises a plurality of N ingredient reservoirs 54. Typically, each reservoir 56 contains at least one ingredient, Iᵢ₌ⱼ. Each reservoir 56 includes a communications port 60, through which each reservoir 56 communicates with the communications line 52 via an internal communication bus 62. In some embodiments, at least one reservoir 56 contains a mixture of at least two ingredients, I_{i=j, i=m}.

A batch of a sample of the food product 10 is input into the vat 14 from a batch manifold 19 via a control valve 21. A pump 34 pumps the composition 18 of the sample from the vat 14 to the food production line 22 via nuclear magnetic imaging device 26. A composition flow 36 flows through the conduit 24. At least a portion, 48, of flow 36 passes through at least a portion of nuclear magnetic imaging device 26, between entrance port 64 and exit port 66.

In further reference to FIG. 3, the nuclear magnetic imaging device 26, which can be an NMR device, generates at least one magnetic resonance image 38 of the portion 48 of composition flow 36 within the NMR device as a function of a radial location r, as is known in the art. The at least one magnetic resonance image 38 is processed by processor 42 to determine at least one radial velocity profile, v(r), 40 of the composition 18, where the radial parameter r is measured from the center of the conduit 24, such that r=0 is the center of the conduit 24 and r=R is the edge of the flow 36. The at least one magnetic resonance image 38 is transferred to the processor 42 via communication line 50 and communication bus 46. In some embodiments, communication line 50 comprises part of communication bus 46.

The radial velocity profile, v(r), 40 and the radial pressure profile P(r) are analyzed in processor 42 to determine rheological parameters of composition 18 such as the radial flow stress, σ(r) and the radial flow shear rate, γ(r), as is known in the art. As is known in the art, the rheological parameters can be related to food criteria such as, but not limited to, aroma and taste.

The radial shear stress distribution σ(r) is determined from

$$σ ( r ) = - \frac{Δ P ( r )}{2 L} r , \qquad ( 1 )$$

where ΔP(r) is the pressure difference between entrance port 64 and exit port 66 of the MRD 26 at radial location r. Pressure sensors are located in proximity to the ports 64 and 66 and the pressure sensors measure an axial pressure profile P(r), as is known in the art. The pressure sensors are separated by a distance L.

The radial shear rate γ(r) distribution is determined from

$$\dot{γ} ( r ) = \frac{d v ( r )}{d r} . \qquad ( 2 )$$

where v(r) is the radial velocity profile 40.

The NMR images 38, the radial velocity profiles v(r) 40, the pressure profiles P(r), the distance L, and the rheological parameters σ(r) and γ(r) can be stored in the memory 44 and can be retrieved from memory as required.

According to a power law distribution for the radial shear stress σ(r), the radial shear stress σ(r) and the radial shear rate γ(r) are related:

σ(r)=k[γ(r)]ⁿ, (3)

where k and n are the power law stress parameters.

Typically, the parameters k and n are determined by fitting an averaged radial shear rate distribution γ(r) and an averaged shear stress distribution σ(r) for the radial values r to the power law distribution in equation (3).

A useful quality parameter, Q, is

Q=\sqrt{k²±n²} (4)
where k and n are found by fitting the averaged radial shear rate distribution γ(r) and the averaged shear stress distribution σ(r) for the radial values r to the power law distribution in equation (3).

In this embodiment, a composition quality parameter, Q_{C}, is compared to a standard quality parameter, Q_{S}, where Q_{C} is

Q_{C}=\sqrt{k_{C}²+n_{C}²} (5)

and Q is

Q_{S}=\sqrt{k_{S}²+n_{S}²}. (6)

In order to determine whether the sample fulfills the criteria, a quality test parameter Q_{T} is compared to a check criterion δ and the sample is acceptable if

i. Q_{T}<δ (7)

In one embodiment,

ii. Q_{T}=|Q_{S}−Q_{C}| (8)
and the check criterion is one standard deviation of the standard quality parameter Q_{S}.

In embodiments where the check criterion δ is one standard deviation of the standard quality parameter Q_{S}, the standard quality parameter Q_{S} is measured for a plurality of standardized samples of the composition and a standard quality parameter Q_{S,i} is determined for each sample i. The standard deviation, D_{S}, of the standard quality parameter Q_{S} is found, as is known in the art, from the equation

$${D}_{s} = \sqrt{\frac{1}{N - 1} {\sum }_{i = 1}^{N} {( {Q}_{S , i} - {Q}_{S} )}^{2}} \qquad ( 9 )$$

where Q_{S,i} is the standard quality parameter for the ith standardized sample of the food product, N is the number of standardized samples tested, and Q_{S} is the mean of the standard quality parameters Q_{S,i},

In another embodiments, the check criterion is two standard deviations (95%) of the standard quality parameter Q_{S}. In yet other embodiments, 3 or 4 standard deviations, or even more, are used as a check criterion.

In order to determine the standard quality parameter Q_{S}, a standardized sample of composition 18 is provided to MRD 26 in conduit 24. This standardized sample would, when processed, form a standardized sample of food product 10, one which fulfills food product criteria such as, for non-limiting example, aroma and taste. The standardized sample contains known quantities of ingredients 16 and is processed according to a known processing protocol. At least one standardized sample is applied to the vat 14 from manifold 19 via control valve 21, and is pumped through food production line 12 to via MRD device 26 to food production line 22. MRD device 26 generates images 38 of the flow 48 of the standardized sample and processor 42 determines a standard quality parameter Q_{S}, as described above.

For a non-limiting example, the standardized sample of the food product 10 includes three ingredients, ingredients I_{i=1,2 or 3}, such as water (Iᵢ₌₁), flour (Iᵢ₌₂) and a flavor substance (Iᵢ₌₃). The quantity of the each ingredient is known such that in the standardized sample, the standardized quantities of the composition 18 are: water, 80%; flour, 19.5%; and flavoring substance, 0.5%.

The processor 42 determines a standard quality parameter Q_{S} for at least one standardized sample and a check criterion δ, in this case, one standard deviation Dₛ. The standardized ingredient data is stored in the memory unit 44, as are the standard quality parameter Q_{S} and the check criterion δ=Dₛ. It is appreciated that the various quantities of the food product can also be stored as weights of the ingredients.

Once the standard quality parameter Q_{S} and the check criterion δ have been determined, production samples of the composition 18 are sent to the vat 14 from the batch manifold 19 by opening the batch control valve 21. Production samples may have non-standard quantities of ingredients or, possibly, unknown quantities of at least one ingredient.

The sample is pumped through the food production line 12 from the vat 14 to the food production device 22 and Q_{C} is determined by the processor 42, as described above. The test parameter Q_{T} is determined as described above, and compared, as described above, to check criterion δ.

If Q_{T}<δ, the sample fulfills the food production criteria and the remainder of the batch in vat 14 is admitted to food production line 22.

If Q_{T}>δ, the sample does not fulfill the food production criteria and the processor 42 sends instructions to the ingredient supply device 32, via communications bus 46 and communications lines 52 and 62, to adjust the quantities of at least one ingredient 54.

Quantities of ingredients 54 are adjusted iteratively by instructing at least one of the ingredient reservoirs 54 to inject a known quantity of an ingredient into the composition 18 contained in the food mixing vat 14. The quantity is incorporated into composition 18, a further sample is supplied, via conduit 24, to MRD device 26, and a new composition quality parameter Q is generated. The process continues iteratively with the above comparing and adjusting procedures, until Q_{T}<δ.

The process is then repeated with a further sample of the composition 18 admitted to vat 14 from the batch manifold 19 by opening the batch control valve 21, and the above process of generating quality test parameters, comparing them to the check criterion δ and, if necessary, adjusting the quantities of ingredients 54 are repeated until all of the composition 18 has been passed to food production line 22.

In other embodiments, adjustments are made to at least one of the processing temperature, the rate of change of processing temperature, the processing time, the mixing rate, the vibration rate, the mixing time, the vibration time, the rate of change of mixing rate, the rate of change of mixing time, and any combinations thereof.

In other embodiments, the process is a continuous process so that vat 14 and batch control valve 21 are not necessary. In such a continuous process, the composition 18 is checked on a continuous or semi-continuous basis, thereby preventing drift in the production process and enabling the process to be stopped if iterative modifications fail to correct the errors.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A system for integrating analysis and production of a food product comprising:
a. food production apparatus for producing a food product in at least one characterized production step;
b. an MRI device configured to provide at least one image of at least a portion of said product's components at said at least one characterized production step; and
c. a processor for analyzing and controlling the production of said product;
wherein said system is operating in a method of
i. analyzing said MRI image online;
ii. operatively communicating results of said analysis to said food production apparatus;
iii. online feedback controlling at least one step in the operation of said food production apparatus, thereby controlling automatically said at least one step in the operation of said apparatus.

2. The system for integrating analysis and production of a food product according to claim 1, wherein said production steps are selected from a group consisting of adding ingredients, mixing, shaking, rotating, tumbling, aerating, heating, cooling, holding at a fixed temperature, emulsifying, kneading, and any combination thereof.

3. The system for integrating analysis and production of a food product according to claim 1, wherein at least one of the following is being held true (a) said means for analyzing at least one criterion of said composition of said food product generates at least one radial velocity profile from said at least one magnetic resonance image; (b) said means for analyzing at least one criterion of said composition of said food product generates at least two radial pressure profiles; and any combination thereof.

4. The system for integrating analysis and production of a food product according to claim 2, wherein said means for analyzing at least one criterion of said composition of said food product generates at least one rheological parameter of said composition of said food product from at least one of said at least one radial velocity profile and said at least two radial pressure profiles.

5. The system for integrating analysis and production of a food product according to claim 4, wherein said at least one rheological parameter is selected from a group consisting of radial shear stress parameter σ(r), radial shear rate parameter γ(r), and any combination of thereof.

6. The system for integrating analysis and production of a food product according to claim 4, wherein said means for analyzing at least one criterion of said composition of said food product generates stress parameters k and n in the power law equation σ(r)=k[γ(r)]ⁿ from rheological parameters radial shear stress parameter σ(r) and radial shear rate parameter γ(r).

7. The system for integrating analysis and production of a food product according to claim 6, wherein said means for analyzing at least one criterion of said composition of said food product is further configured to determine at least one quality parameter Q from said at least one rheological parameter.

8. The system for integrating analysis and production of a food product according to claim 7, wherein said quality parameter is Q=\sqrt{k²+n²}.

9. The system for integrating analysis and production of a food product according to claim 8, wherein standard quality parameter Q_{S}=\sqrt{k_{S}²+n_{S}²} is generated from analysis of a standardized sample of said food product composition, said analysis of said standardized sample generating standardized stress parameters k_{S} and n_{S} in the power law equation σ_{S}(r)=k_{S}[γ_{S}(r)]ⁿ^{_{S}} from rheological parameters standardized radial shear stress parameter σ_{S}(r) and standardized radial shear rate parameter γ_{S}(r).

10. The system for integrating analysis and production of a food product according to claim 8, wherein composition quality parameter Q_{C}=\sqrt{k_{C}²+n_{C}²} is generated from analysis of a sample of said food product composition, said analysis of said composition sample generating composition stress parameters k_{C} and n_{C} in the power law equation σ_{C}(r)=k_{C}[γ_{C}(r)]ⁿ^{_{C}} from rheological parameters composition radial shear stress parameter σ_{C}(r) and composition radial shear rate parameter γ_{C}(r).

11. The system for integrating analysis and production of a food product according to claims 11, wherein a quality test parameter is: Q_{T}=|Q_{S}−Q_{C}|.

12. The system for integrating analysis and production of a food product according to claim 11, wherein said quality criterion is: said quality test parameter is smaller than one standard deviation of said standard quality parameter.

13. The system for integrating analysis and production of a food product according to claim 12, wherein said standard deviation is one standard deviation of either said standard quality parameter or said composition quality parameter.

14. The system for integrating analysis and production of a food product according to claim 1, wherein said alterable at least one parameter is selected from a group consisting of addition of an ingredient, the rate of addition of an ingredient, mixing rate, mixing time, rate of change of mixing rate, shaking rate, shaking time, rate of change of shaking rate, rotation rate, rotation time, rate of change of rotation rate, tumbling rate, tumbling time, rate of change of tumbling rate, aeration rate, aeration time, rate of change of aeration rate, heating rate, heating time, rate of change of heating rate, shaking rate, shaking time, rate of change of heating rate, cooling rate, cooling time, rate of change of cooling rate, time held at a constant temperature, emulsification rate, emulsification time, rate of change of emulsification rate, kneading rate, kneading time, rate of change of kneading rate, and any combination thereof.

15. The system for integrating analysis and production of a food product according to claim 14, wherein said alterable at least one parameter comprises addition of an ingredient; said ingredient stored in an said ingredient supply system comprising a plurality of ingredient supply reservoirs, each reservoir of said plurality of ingredient supply reservoirs comprising at least one ingredient of said plurality of ingredients.

16. The system for integrating analysis and production of a food product according to claim 1, wherein at least one of the following is being held true (a) if said quality parameter satisfies said quality criterion, a further batch of said food composition is input to said food production line; (b) if said quality parameter does not satisfy said quality criterion, said processor instructs said ingredient supply system to inject a quantity of at least one ingredient into said composition; (c) said at least one criterion of at least one composition of said food product is selected based on its relationship to at least one of a group consisting of: food product aroma, and food product taste; (d) at least a part of said food production equipment is configured to comply with a NeSSI specification; (e) at least a part of said food production equipment is configured to comply with ANSI/ISA SP76.00.2002 miniature, modular mechanical standard specifications; (f) said food production equipment comprises a NeSSI communication bus; and any combination thereof.

17. A method for integrating analysis and production of a food product comprising steps of:
a. providing a system for integrating analysis and production of a food product comprising:
i. food production apparatus for producing a food product in at least one characterized production step;
ii. an MRI device configured to provide at least one image of at least a portion of said product's components at said at least one characterized production step; and
iii. a processor for analyzing and controlling the production of said product;
b. providing at least one sample of said food product at said characterized production step;
c. MRI imaging said sample of said food product at said characterized production step;
d. analyzing said MRI image online;
e. operatively communicating results of said analysis to said food production apparatus, thereby enabling automatic online control of production; and
f. online feedback controlling at least one step in the operation of said food production apparatus, thereby controlling automatically said at least one step in the operation of said apparatus.

18. The method for integrating analysis and production of a food product according to claim 17, additionally comprising at least one step selected from a group consisting of (a) selecting said food production steps from a group consisting of adding ingredients, mixing, shaking, rotating, tumbling, aerating, heating, cooling, holding at a fixed temperature, emulsifying, kneading, and any combination thereof; (b) determining a standardized quality parameter, said standardized quality parameter determined from said analysis of said at least one sample of said at least one standardized composition of said food product; (c) determining a quality criterion from said analysis of said at least one sample of said at least one standardized composition of said food product; (e) analyzing said composition of said food product to generate at least one radial velocity profile of said composition of said food product from said at least one magnetic resonance image; and any combination thereof.

19. The method for integrating analysis and production of a food product according to claim 17, additionally comprising a step of generating at least two radial pressure profiles of said composition of said food product.

20. The method for integrating analysis and production of a food product according to claim 19, additionally comprising a step generating at least one rheological parameter of said composition of said food product from at least one of said at least one radial velocity profile and said at least two radial pressure profiles.

21. The method for integrating analysis and production of a food product according to claim 20, additionally comprising at least one step selected from a group consisting of (a) selecting said at least one rheological parameter from a group consisting of radial shear stress parameter σ(r), radial shear rate parameter γ(r), and any combination of thereof; (b) generating stress parameters k and n in the power law equation σ(r)=k[γ(r)]ⁿ from rheological parameters radial shear stress parameter σ(r) and radial shear rate parameter γ(r); and any combination thereof.

22. The method for integrating analysis and production of a food product according to claim 21, additionally comprising a step of determining at least one quality parameter Q from said at least one rheological parameter.

23. The method for integrating analysis and production of a food product according to claim 22, additionally comprising a step of generating said quality parameter from
Q=\sqrt{k²+n²}.

24. The method for integrating analysis and production of a food product according to claim 23, additionally comprising a step of generating standard quality parameter Q_{S}=\sqrt{k_{S}²+n_{S}²} from analysis of a standardized sample of said food product composition, said analysis of said standardized sample generating standardized stress parameters k_{S} and n_{S} in the power law equation σ_{S}(r)=k_{S}[γ_{S}(r)]ⁿ^{_{S}} from rheological parameters standardized radial shear stress parameter σ_{S}(r) and standardized radial shear rate parameter γ_{S}(r).

25. The method for integrating analysis and production of a food product according to claim 23, additionally comprising a step of generating composition quality parameter Q_{C}=\sqrt{k_{C}²+n_{C}²} from analysis of a sample of said food product composition, said analysis of said composition sample generating composition stress parameters k_{C} and n_{C} in the power law equation σ_{C}(r)=k_{C}[γ_{C}(r)]ⁿ^{_{C}} from rheological parameters composition radial shear stress parameter σ_{C}(r) and composition radial shear rate parameter γ_{C}(r).

26. The method for integrating analysis and production of a food product according to claim 24, additionally comprising a step of generating quality test parameter Q_{T}=|Q_{S}−Q_{C}|.

27. The method for integrating analysis and production of a food product according to claim 26, additionally comprising at least one step selected from a group consisting of (a) setting said quality criterion as: said quality test parameter is smaller than one standard deviation of said standard quality parameter; (b) setting said quality criterion as: said quality test parameter is smaller than one standard deviation of said composition quality parameter; and any combination thereof.

28. The method for integrating analysis and production of a food product according to claim 17, additionally comprising a step of selecting said alterable at least one parameter from a group consisting of addition of an ingredient, the rate of addition of an ingredient, mixing rate, mixing time, rate of change of mixing rate, shaking rate, shaking time, rate of change of shaking rate, rotation rate, rotation time, rate of change of rotation rate, tumbling rate, tumbling time, rate of change of tumbling rate, aeration rate, aeration time, rate of change of aeration rate, heating rate, heating time, rate of change of heating rate, shaking rate, shaking time, rate of change of heating rate, cooling rate, cooling time, rate of change of cooling rate, time held at a constant temperature, emulsification rate, emulsification time, rate of change of emulsification rate, kneading rate, kneading time, rate of change of kneading rate, and any combination thereof.

29. The method for integrating analysis and production of a food product according to claim 28, additionally comprising a step of selecting addition of an ingredient as at least one said alterable at least one parameter; said ingredient stored in an said ingredient supply system comprising a plurality of ingredient supply reservoirs, each reservoir of said plurality of ingredient supply reservoirs comprising at least one ingredient of said plurality of ingredients.

30. The method for integrating analysis and production of a food product according to claim 17, additionally comprising at least one step selected from a group consisting (a) inputting a further batch of said food composition to said food production line if said quality parameter satisfies said quality criterion; (b) injecting a quantity of at least one ingredient into said composition if said quality parameter does not satisfy said quality criterion; (c) selecting said at least one criterion of at least one composition of said food product based on its relationship to at least one of a group consisting of: food product aroma, and food product taste; (d) configuring at least a part of said food production equipment to comply with a NeSSI specification; (e) configuring at least a part of said food production equipment to comply with ANSI/ISA SP76.00.2002 miniature, modular mechanical standard specifications; (f) providing at least a part of said food production equipment with a NeSSI communication bus; (g) repeating said comparing and said adjusting iteratively for each remaining batch of said plurality of batches; (h) selecting at least one food product criterion in accordance with customer requirements; (i) selecting at least one food product criterion from a group consisting of: food product aroma, food product taste and any combination thereof; and any combination thereof.
